(19) United States
(12) Patent Application Publication
(10) Pub. No.: US 2006/0071988 A1
(43) Pub. Date: Apr. 6, 2006

(54) System and method for integrated tape seal package

(76) Inventors: Charles Morton, Leander, TX (US); Wayne Iltis, Austin, TX (US)

Correspondence Address: HAMILTON & TERRILE, LLP, P.O. BOX 203518, AUSTIN, TX, 78720, US

(21) Appl. No.: 10/957,917

(22) Filed: Oct. 4, 2004

(51) Int. Cl. B41J 2/175

(52) U.S. Cl. 347/86

(57) ABSTRACT

Products having sensitive regions, such as information handling system components have electrical connections or openings, are packaged with the sensitive region sealed. A sealing portion on the inner surface of a wrapper has an adhesive surface that adheres the wrapper to the sensitive region so that the wrapper encloses the product with the sensitive portion sealed. For instance, an ink jet cartridge printhead adheres to the sealing portion so that enclosing the cartridge in the wrapper packages the cartridge with the printhead sealed. Removal of the wrapper from the cartridge exposes the printhead for use in an inkjet printer.

### BACKGROUND OF THE INVENTION

1. Field of the Invention

The present invention relates in general to the field of product packaging, and more particularly to a system and method for integrated tape seal packaging of inkjet printer cartridges.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with a number of peripherals to communicate, print or otherwise process information. For instance, ink jet printers are typically used to print information, such as documents and photographs, onto print media. Ink jet printers use consumable cartridges that are replaced as the ink within the cartridges is used up. Information handling system users generally purchase inkjet cartridges in stores or from on-line ordering services that ship the cartridges via mail or other delivery services. Often, information handling system users will maintain an inventory of cartridges so that a fresh cartridge is available when an existing cartridge is consumed. In order to protect the cartridges during shipment and storage, inkjet cartridge manufacturers typically package the cartridges in sealed foil bags. In addition, in order to protect the sensitive inkjet printheads that are shaped to fit into the inkjet printers, inkjet cartridge manufacturers typically place a separate piece of tape over the printheads within the foil bag. Thus, a user generally must remove a replacement inkjet cartridge from its foil bag and remove the tape covering the printheads before the user installs the inkjet cartridge in the inkjet printer.

Although a foil bag and separate tape packaging arrangement generally succeeds in protecting an inkjet cartridge until it is installed for use, such an arrangement introduces a number of difficulties to the manufacture and use of inkjet cartridges. For instance, one difficulty that arises during manufacture is the time and cost associated with both applying the tape to the printhead and sealing the cartridge in the foil bag. The performance of each packaging step separately takes additional time, and the use of separate bag and tape materials increases packaging costs. Another example of a difficulty that arises with the bag and tape arrangement during use is that users will sometimes forget to remove the tape from the inkjet cartridge. Installing the inkjet cartridge into an inkjet printer with the tape still attached leads to an inability to print and may cause permanent damage to printer components. Users who fail to identify their mistake on their own instead often call the printer or information handling system manufacturer for help in fixing the failed printer. Such calls are embarrassing for the user, resulting in a degraded user experience, and expensive for the manufacturer who maintains telephone support staff to resolve warranty issues. Although inkjet print cartridges provide an example of separate tape and bag packaging arrangements, similar arrangements may be used in other information handling system component packaging where, for instance, electronic components are separately covered or sealed during shipping.

### SUMMARY OF THE INVENTION

Therefore a need has arisen for a system and method which integrates a product surface seal with a package wrapper that encloses the product.

In accordance with the present invention, a system and method are provided which substantially reduce the disadvantages and problems associated with previous methods and systems for packaging products that have surface sealed within a bag that encloses the product. Adherent on the inner surface of a wrapper seals a sensitive region of the product so that sealing the wrapper into a bag that encloses the product integrates the product surface seal with the product packaging bag.

More specifically, an inkjet cartridge has a sensitive printhead region with openings and electrical connections for dispensing ink when installed in an ink jet printer. A wrapper used to package the inkjet cartridge has an adhesive disposed on a sealing portion of the wrapper inner surface. The sealing portion is sized to cover the printhead and, in one embodiment, is marked for identification, such as with a color code. The inkjet cartridge is packaged by pressing the printhead against the sealing portion to adhere the printhead to the wrapper and then by sealing the wrapper around the inkjet cartridge. When the inkjet cartridge is selected for use, removal of the wrapper that encloses the cartridge also exposes the printhead for insertion in the inkjet printer.

The present invention provides a number of important technical advantages. One example of an important technical advantage is that products having a sealed surface are packaged in an enclosing bag that integrates the sealing surface. The integrated sealing surface reduces packaging steps and materials so that packaging of a product has improved simplicity and a reduced cost. Further, package removal is simplified in that removal of the enclosing bag removes the sealed surface and exposes the product for installation. Thus, for instance, ink jet cartridge printheads are exposed for coupling to an ink jet printer on removal of the package, thereby reducing user confusion compared with packaging that has a separately-removed tape seal.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a perspective view of an inkjet cartridge for packaging in a wrapper having an integrated sealing portion;

FIG. 2 depicts a top view of the inkjet cartridge pressed against the sealing portion for enclosure by the wrapper; and

FIG. 3 depicts a side view of the inkjet cartridge packaged in the wrapper with the integrated sealing portion sealing the cartridge printhead.

### DETAILED DESCRIPTION

Information handling system components having sensitive regions, such as electrical connections or openings, are packaged with the sensitive portion sealed in a wrapper having an integrated sealing portion. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

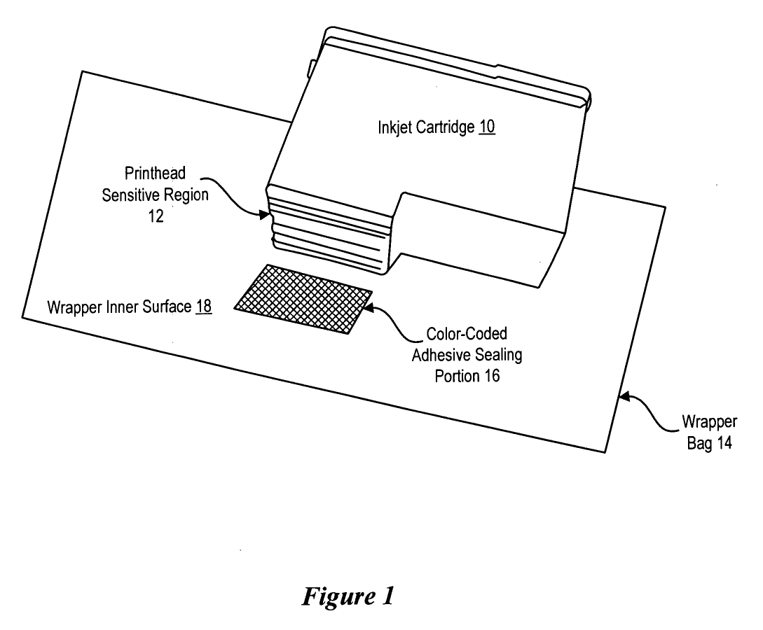

Referring now to FIG. 1, a perspective view depicts an inkjet cartridge for packaging in a wrapper having an integrated sealing portion. Inkjet cartridge 10 has a printhead sensitive region 12 that interfaces with an inkjet printer to dispense ink. For instance, printhead 12 has openings for releasing ink and electrical connections that are sealed after production to reduce the risk of entry of contaminants that may lead to failure of the cartridge. Conventional packaging of inkjet cartridge 10 involves two steps of sealing printhead 12 with tape and then enclosing cartridge 10 in a wrapper foil bag. To reduce packaging material and steps, a wrapper bag 14 adheres to printhead sensitive region 12, thus sealing printhead 12 with the wrapper bag material that subsequently encloses around cartridge 10.

Wrapper bag 14 has a color-coded adhesive sealing portion 16 disposed on its inner surface 18. For instance, the adhesive is sprayed or otherwise applied to wrapper 14 in a shape sized to adhere to printhead 12 and seal desired portions of printhead 12. The adhesive has color added or is applied over a colored region of wrapper 14 to aid in the alignment of printhead 12 with sealing portion 16. Color coding also helps to ensure complete removal of wrapper 14 from printhead 12 when wrapper 14 is removed from cartridge 10. Sealing of printhead 12 is accomplished by pressing sealing portion 16 against printhead 12 to have wrapper inner surface 18 adhere to printhead 12.

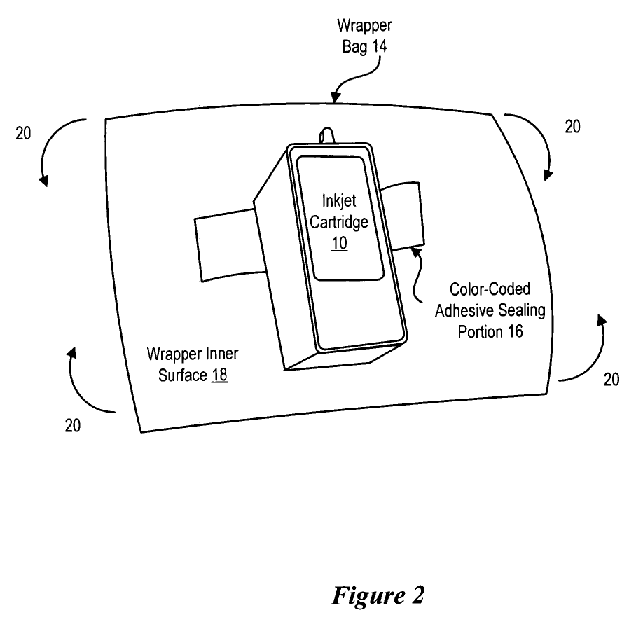

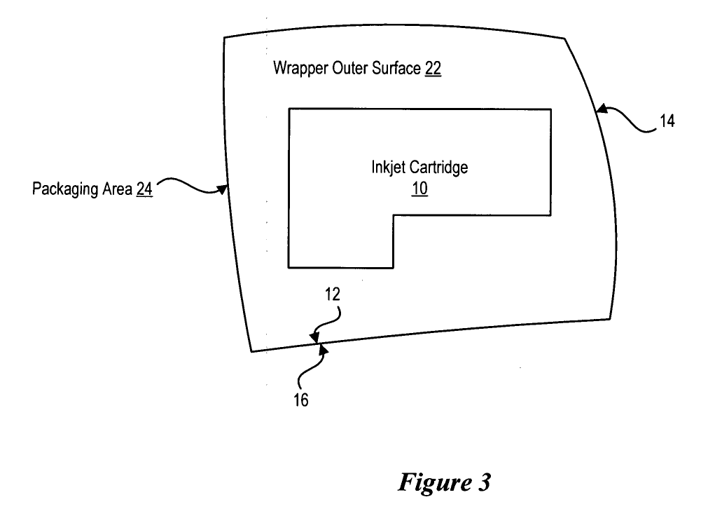

Referring now to FIG. 2, a top view depicts inkjet cartridge 10 pressed against sealing portion 16 and prepared for enclosure by the wrapper 14. Arrows 20 depict how wrapper 14 encloses cartridge 10 while printhead 12 is sealed by adhering to sealing portion 16. FIG. 3 depicts a side view of inkjet cartridge 10 packaged in the wrapper 14 with the integrated sealing portion sealing the cartridge printhead 12. Wrapper outer surface 22 wraps around cartridge 10 so that inner surface 18 forms a packaging area 24. Inner surface 18 of wrapper 14 adheres at sealing portion 16 to printhead 12 to seal printhead 12 against contaminants. Upon selection for use, inkjet cartridge 12 is removed from wrapper 14 to expose printhead 12 for insertion in an inkjet printer. In alternative embodiments, other products may be packaged with an integrated sealing portion of wrapper 14 that protects a sensitive region of the product, such as laser toner cartridges or other information handling system components.

Although the present invention has been described in detail, it should be understood that various changes, substitutions and alterations can be made hereto without departing from the spirit and scope of the invention as defined by the appended claims.

What is claimed is:

1. A system for packaging a product having an exterior, the exterior having a sensitive region, the system comprising:
a bag having inner and outer surfaces, the bag operable to seal to enclose a packaging area within the inner surface, the packaging area sized to enclose the product; and
an adhesive disposed along a sealing portion of the inner surface, the sealing portion sized to cover the sensitive region and operable to couple the sealing portion to the sensitive region within the packaging area.

2. The system of claim 1 further comprising the product wherein the sensitive region comprises openings formed in the exterior.

3. The system of claim 2 wherein the product is an inkjet printer cartridge and the openings is a printhead.

4. The system of claim 1 further comprising a color coding associated with the adhesive and operable to indicate the sealing portion of the inner surface.

5. A method for packaging a product, the method comprising:
disposing an adhesive at a sealing portion of the inner surface of a wrapping material;
pressing a sensitive region of the product against the adhesive to couple the sealing portion to the sensitive region; and
sealing the wrapping material to enclose the product.

6. The method of claim 5 further comprising:
removing the wrapper from the product to expose the sensitive region.

7. The method of claim 5 further comprising:
coloring the adhesive to identify the sealing portion.

8. The method of claim 5 wherein the product comprises an ink jet cartridge and the sensitive region comprises a printhead.

9. A package comprising:
an ink jet cartridge having a printhead;
a wrapping material having an interior surface; and
an adhesive disposed on the wrapping material interior surface proximate the printhead to seal the printhead with the wrapping material;
wherein the wrapping material seals to enclose the product within the interior surface.

10. The package of claim 9 further comprising coloring associated with the adhesive.

11. A method for packaging an inkjet cartridge having a printhead in a wrapper, the method comprising:
adhering the printhead to the interior surface of the wrapper to seal the printhead; and
sealing the inkjet cartridge within the interior of the wrapper.

12. The method of claim 11 further comprising:
spreading adherent over a sealing portion of the wrapper; and
aligning the printhead with the sealing portion.

13. The method of claim 12 further comprising:
marking the adherent to identify the sealing portion.

14. The method of claim 12 further comprising:
removing the wrapper from the inkjet cartridge; and
inserting the inkjet cartridge into an inkjet printer.
